(19) United States
(12) Patent Application Publication
(10) Pub. No.: US 2023/0405924 A1
(43) Pub. Date: Dec. 21, 2023

(54) Heated Nozzle Assembly for a Three-Dimensional Printer Head Including a Plurality of Heater Segments

(71) Applicant: Essentium, Inc., Pflugerville, TX (US)

(72) Inventors: Vahid Safavi-Ardebili, Irvine, CA (US); Jorge Arturo Mijares Tobias, Puebla (MX); Iris Gisey Euan Waldestrand, Puebla (MX); Kristian Oftebro, Irvine, CA (US); Chad Eichele, Lake Forest, CA (US)

(21) Appl. No.: 17/845,027

(22) Filed: Jun. 21, 2022

(51) Int. Cl. B29C 64/209; B29C 64/118; B29C 64/295; B29C 64/393

(52) U.S. Cl. CPC B29C 64/209; B29C 64/118; B33Y 30/00; B29C 64/393; B29C 64/295

(57) ABSTRACT

A heated nozzle assembly for a three-dimensional printer includes a shank defining a feed end and a first internal flow passage, where the feed end is fluidly coupled to the first internal flow passage. The heated nozzle assembly also includes a shank barrel coupled to the shank that includes a second internal flow passage and a body portion. The second internal flow passage of the shank barrel is fluidly coupled to the first internal flow passage of the shank and the body portion of the shank barrel defines a plurality of heater segments that are disposed along the body portion of the shank barrel that are thermally isolated from one another. The heated nozzle assembly includes a plurality of heating elements that each correspond to one of the plurality of heater segments disposed along the length of the body portion of the shank barrel.

### FIELD

The present disclosure is directed to a heated nozzle assembly for a three-dimensional printer head, where the heated nozzle assembly includes a shank barrel including a plurality of heater segments that are individually activated to adjust a heat diffusion length of the heated nozzle and to control a melt front.

### BACKGROUND

The statements in this section merely provide background information related to the present disclosure and may or may not constitute prior art.

Three-dimensional printing, which is also referred to as additive manufacturing, creates printed components based on computer models. One example of a three-dimensional printing technique is fused deposition molding (FDM), which employs a continuous filament constructed of a thermoplastic material that is fed to a heated nozzle. The body of the heated nozzle includes a cold zone at an entry port where the filament enters, and a hot zone that extends towards a discharge end of the heated nozzle. The temperature of the hot zone of the heated nozzle is greater than a melt temperature of the thermoplastic material that the filament is constructed of, thereby melting the thermoplastic material of the filament. The three-dimensional printer extrudes molten thermoplastic material from the discharge end of the heated nozzle. Specifically, the heated nozzle deposits the thermoplastic material upon a build substrate to create a printed component. A heat break is disposed between the cold zone and the hot zone of the heated nozzle and blocks the flow of heat from the hot zone to the cold zone.

There is an ongoing effort to increase the deposition speed of the filament, which results in faster print speeds of the three-dimensional printer. However, several factors that may limit the deposition speed of the filament currently exist. For example, one common practice for increasing the print speed involves increasing the temperature of the hot zone of the heated nozzle, however, increasing the temperature of the hot zone is limited by the onset of thermal degradation of plastic. In another approach to increase the print speed, an overall length of the hot zone of the heated nozzle may be increased. However, increasing the length of the hot zone of the heated nozzle may impede the ability to print relatively fine features of the printed component, such as sharp corners. This is because the flow of molten thermoplastic material may need to be slowed down or stopped when printing fine features. For example, the flow of thermoplastic material is stopped when the nozzle is translated between unconnected areas of the printed component. However, the longer the heated nozzle, the more difficult it is to slow or stop the flow of molten thermoplastic material.

In one approach to alleviate the issue of printing fine features when having a relatively long heated nozzle, the temperature of the heated nozzle is modulated as rapidly as possible to achieve uniform process between areas of the printed component that are printed at relatively high speeds, such as long continuous stretches of print path, and areas of the printed component that are printed relatively slowly, such as fine detail. However, the hot zone of the nozzle stores a given amount of heat that may limit the ability of the heated nozzle to rapidly heat up and cool down. Accordingly, sometimes the hot zone of the nozzle may have a relatively thin wall thickness, which in turn results in less stored heat. However, relatively thin wall thicknesses may result in hot spots along inside surfaces of the hot zone of the heated nozzle during rapid heating. Hot spots along the inside surfaces of the hot zone may degrade the thermoplastic material of the filament, which leads to a clogged nozzle or non-uniform color of the printed component.

In addition to the above-mentioned challenges regarding deposition speed, existing heated nozzles usually only have one temperature sensor to measure temperature. However, the heating element for a nozzle body is usually distributed along a length of the nozzle body. For example, in one approach, a heating coil may be wrapped around nozzle body to distribute heat as evenly as possible along the nozzle body, however, temperature variations may still occur. It is to be appreciated that the temperature variations are more difficult to detect when only one temperature sensor is employed. The variations may lead to localized hot spots or areas of increased temperature along the nozzle body.

Thus, while current heated nozzles used in three-dimensional printers achieve their intended purpose, there is a need for an improved heated nozzle that overcomes the above-mentioned challenges.

### SUMMARY

According to several aspects, a heated nozzle assembly for a three-dimensional printer. The heated nozzle assembly includes a shank defining a feed end and a first internal flow passage, where the feed end is fluidly coupled to the first internal flow passage. The heated nozzle assembly includes a shank barrel coupled to the shank that includes a second internal flow passage and a body portion, where the second internal flow passage of the shank barrel is fluidly coupled to the first internal flow passage of the shank and the body portion of the shank barrel defines a plurality of heater segments that are disposed along the body portion of the shank barrel that are thermally isolated from one another. The heated nozzle assembly includes a plurality of heating elements that each correspond to one of the plurality of heater segments disposed along a length of the body portion of the shank barrel, where the heating elements are each configured to heat a corresponding heater segment to a predefined temperature.

In another aspect, a three-dimensional printer is disclosed and includes a control circuit and a print head including a heated nozzle assembly. The heated nozzle assembly includes a shank defining a feed end and a first internal flow passage, where the feed end is fluidly coupled to the first internal flow passage. The heated nozzle assembly includes a shank barrel coupled to the shank that includes a second internal flow passage and a body portion, wherein the second internal flow passage of the shank barrel is fluidly coupled to the first internal flow passage of the shank and the body portion of the shank barrel defines a plurality of heater segments that are disposed along the body portion of the shank barrel that are thermally isolated from one another. The heated nozzle assembly includes a plurality of heating elements in electronic communication with the control circuit, where the plurality of heating elements each correspond to one of the plurality of heater segments disposed along a length of the body portion of the shank barrel. The heating elements are each configured to heat a corresponding heater segment to a predefined temperature, and the control circuit activates or deactivates one or more of the plurality of heating elements.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 is a schematic diagram of a three-dimensional printer including a print head that includes disclosed heated nozzle assembly, according to an exemplary embodiment;

FIG. 2 is a cross-sectioned view of the heated nozzle assembly shown in FIG. 1 including a plurality of heater segments that are heated by respective heating elements, according to an exemplary embodiment;

FIG. 3 is an elevated perspective view of the heated nozzle assembly shown in FIG. 2, according to an exemplary embodiment;

FIGS. 4A and 4B are alternative embodiments of the heated nozzle shown in FIG. 2, where FIG. 4A illustrates the heating elements as inductive heating elements only, and FIG. 4B the heating elements as a combination of ohmic heating elements and inductive heating elements, according to an exemplary embodiment;

FIGS. 5A and 5B illustrate a control circuit for activating or deactivating one or more of the plurality of heating elements, where FIG. 5A illustrates the control circuit including a plurality of electrical switching elements connected in series and FIG. 5B illustrates the electrical switch elements connected in parallel, according to an exemplary embodiment; and

FIG. 6 is another embodiment of the control circuit shown in FIGS. 5A and 5B, according to an exemplary embodiment.

### DETAILED DESCRIPTION

The following description is merely exemplary in nature and is not intended to limit the present disclosure, application, or uses.

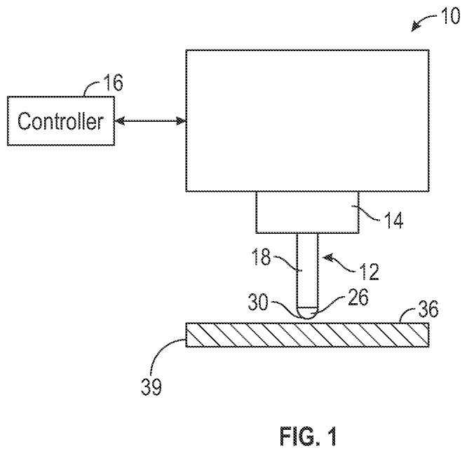

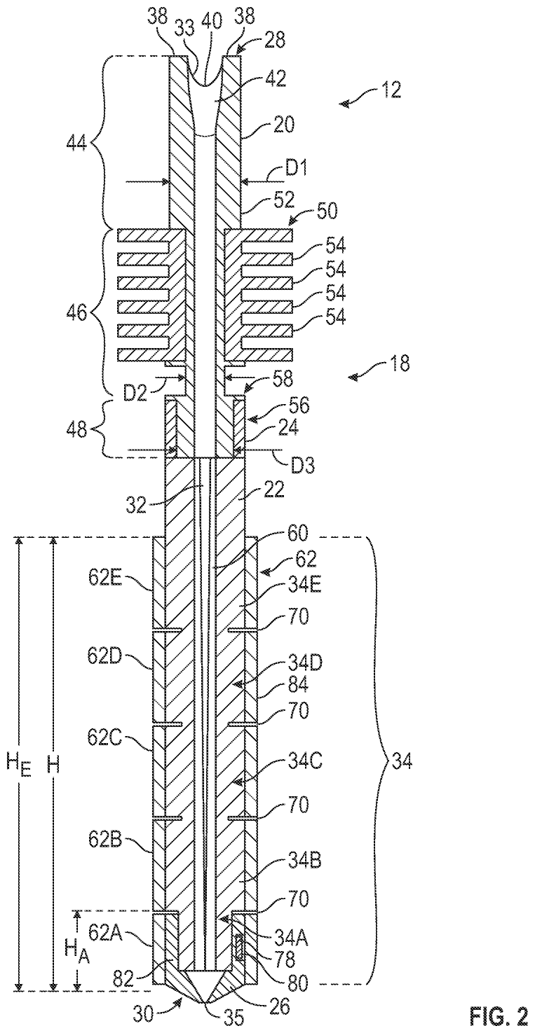

The present disclosure is directed to a printer head including a heated nozzle assembly for a three-dimensional printer head, where the heated nozzle includes a shank barrel including a plurality of heater segments that are individually activated to adjust a heat diffusion length of the heated nozzle. Referring now to FIGS. 1 and 2, a three-dimensional printer 10 including a heated nozzle assembly 12 is shown. Referring specifically to FIG. 1, the three-dimensional printer 10 includes a printer head 14 that includes the heated nozzle assembly 12 in electronic communication with one or more controllers 16. Referring to FIG. 2, the heated nozzle assembly 12 includes a nozzle 18 including a shank 20, a shank barrel 24, a nozzle tip 26, a feed end 28, and a discharge end 30. A bore 32 starts at an opening 33 located at the feed end 28, extends through an entire length of the nozzle 18, and terminates at the discharge end 30, which is disposed at the nozzle tip 26 of the nozzle 18. The feed end 28 of the nozzle 18 receives a filament (not shown) constructed of a thermoplastic material through the opening 33. The shank barrel 24 includes a plurality of discrete heater segments 34 that are disposed along a body portion 22 of the shank barrel 24, where the heater segments 34 heat the thermoplastic material of the filament into molten thermoplastic material. Referring to both FIGS. 1 and 2, the heated filament in the form of a molten thermoplastic material exits the bore 32 through an opening 35 located at the discharge end 30 of the nozzle 18 and is deposited onto a build surface 36 of a build plate 39 that is part of the three-dimensional printer 10. As explained below, the plurality of heater segments 34 are individually activated by the controller 16 to adjust a heat diffusion length H of the heated nozzle assembly 12.

The heat diffusion length H of the heated nozzle assembly 12 is based on an input velocity of the filament received by the feed end 28 of the heated nozzle assembly 12 and a heat diffusion time. The heat diffusion time represents an amount of time required for heat to diffuse radially to a center of the filament to achieve a homogenous temperature as the filament exits the nozzle 18 through the discharge end 30 as molten thermoplastic material. Specifically, the heat diffusion length H is the product of the input velocity of the filament multiplied by the heat diffusion time. As explained below, the individual heater segments 34 are activated dynamically to adjust the heat diffusion length H of the nozzle 18 as the print speed of the three-dimensional printer is changed. It is to be appreciated that in embodiments, the disclosed heated nozzle assembly 12 may be a retrofit part that is incorporated into an existing printer head or, in the alternative, is part of the original printer head.

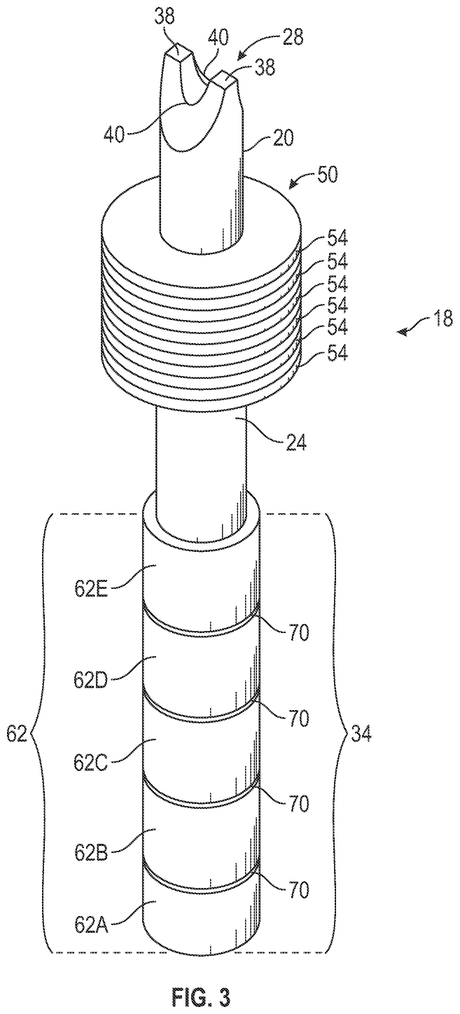

FIG. 3 is an elevated perspective view of the heated nozzle assembly 12 shown in FIG. 2. Referring to FIGS. 2 and 3, the feed end 28 of the shank 20 defines two opposing peaks 38 and two opposing valleys 40 (only one valley 40 is visible in FIG. 2). The peaks 38 and valleys 40 may assist in guiding the filament into the bore 32 through the feed end 28 of the nozzle 18. Although FIG. 3 illustrates the peaks 38 and valleys 40, it is to be appreciated that in embodiments these features may be omitted, or alternative guide features may be used instead. The shank 20 includes the feed end 28 of the nozzle 18, a first internal flow passage 42, a first diameter portion 44, a second diameter portion 46, and a third diameter portion 48. The feed end 28 of the shank 20 is fluidly coupled to the first internal flow passage 42. The first diameter portion 44 of the shank 20 includes a first diameter D1, where the first diameter D1 of the first diameter portion 44 is greater than a second diameter D2 of the second diameter portion 46 of the shank 20. As seen in FIG. 2, the third diameter portion 48 of the shank 20 includes a third diameter D3. The second diameter D2 of the second diameter portion 46 is less than the third diameter D3 of the third diameter portion 48 of the shank 20. Thus, the second diameter portion 46 of the shank 20 is an area of reduced diameter, which is also referred to as a necked down section of the shank 20. The necked down section of the shank 20 acts as a heat break to dissipate heat by conduction. Referring to both FIGS. 2 and 3, in embodiments, a heat sink 50 surrounds and contacts at least a portion of the second diameter portion 46 along an outer surface 52 of the shank 20. The heat sink 50 includes a plurality of fins 54 that may further dissipate heat.

Referring to FIG. 2, the shank barrel 24 is coupled to the shank 20. Specifically, in one non-limiting embodiment, an end portion 56 of the shank barrel 24 is threadingly engaged with an end portion 58 of the shank 20. In one embodiment, both the shank barrel 24 and the shank 20 are constructed of the same material. However, in an alternative embodiment, the shank barrel 24 and the shank 20 are constructed of different materials. In one example, the shank barrel 24 and the shank 20 are constructed of dissimilar materials having different thermal conductivities, therefore creating a heat break between the end portion 56 of the shank barrel 24 and the end portion 58 of the shank 20. In an embodiment, the shank 20 may be constructed of materials such as titanium grade 5, Zirconia, and materials with a similar heat conduction, and the shank barrel 24 is constructed of tungsten carbide and tungsten copper alloys, however, it is to be appreciated that other materials with similar values for conductivity and heat diffusivity may be used as well.

The shank barrel 24 defines a second internal flow passage 60, the body portion 22, and the plurality of heater segments 34 that are disposed along the body portion 22. The nozzle tip 26 includes the discharge end 30 of the nozzle 18. The second internal flow passage 60 of the shank barrel 24 is fluidly coupled to the first internal flow passage 42 of shank 20 and the discharge end 30 of the nozzle tip 26, where the filament exits the second internal flow passage 60 as molten thermoplastic material and is extruded through the discharge end 30 of the nozzle 18. In the non-limiting embodiment as shown in FIG. 2, the shank barrel 24 includes five individual heater segments 34A, 34B, 34C, 34D, 34E that are positioned lengthwise along the shank barrel 24 of the nozzle 18. Although FIG. 2 illustrates five individual heater segments 34, it is to be appreciated that the figures are merely exemplary in nature, and more or less heater segments may be used as well. A plurality of heating elements 62A, 62B, 62C, 62D, 62E each correspond to one of the plurality of discrete heater segments 34 disposed along the body portion 22 of the shank barrel 24, where the heating elements 62 are each configured to heat a corresponding heater segment 34 to a predefined temperature. The predefined temperature is greater than a melt temperature of the thermoplastic material of the filament that is deposited into the feed end 28 of the nozzle 18.

The individual heater segments 34 are thermally isolated from one another by one or more heat breaks 70 disposed between two heater segments 34, where a heat break 70 thermally isolates two heater segments 34 from one another. In the embodiment as shown in FIG. 2, the heat breaks 70 include are air gaps located between the two heater segments 34. Specifically, each heat break 70 represents a circumferential cut that penetrates through a portion of the body portion 22 of the shank barrel 24. The heat breaks 70 disposed between the heater segments 34 may prevent the spread of heat between adjacent heater segments 34 and confines the flow of heat to the radial direction.

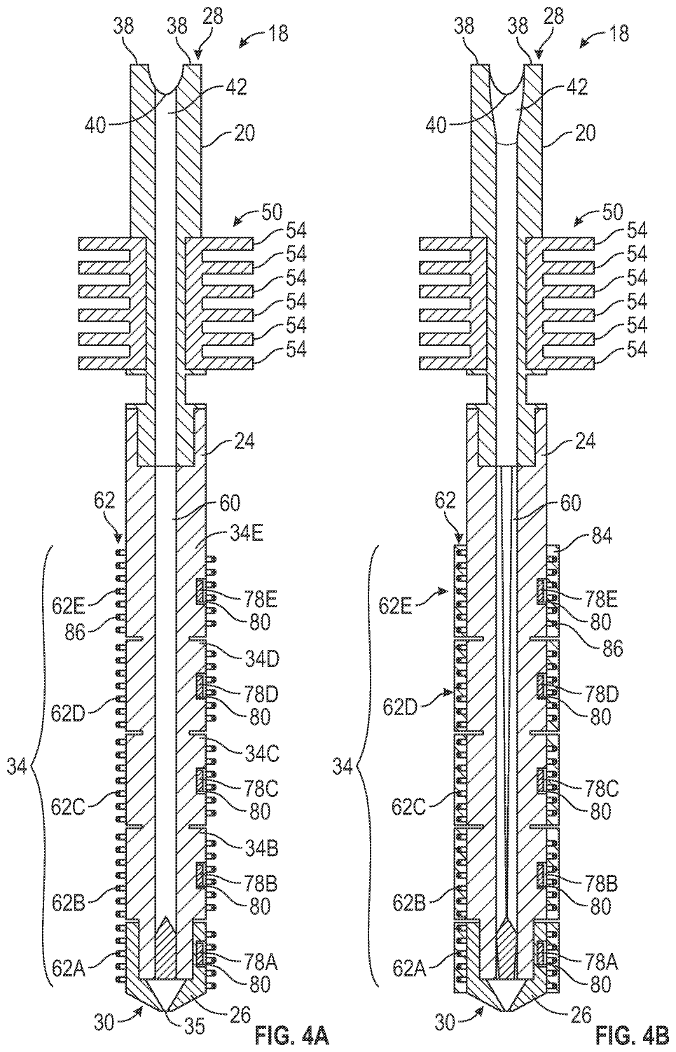

The nozzle 18 also includes one or more temperature sensors 78 for detecting a temperature of the shank barrel 24. The temperature sensors 78 may be, for example, resistance temperature detector (RTD) sensors. In the embodiment as shown in FIG. 2, a single temperature sensor 78 is disposed within a channel 80 formed within a body portion 82 of the nozzle tip 26 for monitoring a temperature of the shank barrel 24. FIG. 2 also illustrates the temperature sensor 78 disposed at a first or bottom heater segment 34A, where the bottom heater segment 34A is located directly adjacent to the discharge end 30 of the nozzle 18. The channel 80 allows for the temperature sensor 78 to be located closer to the bore 32 of the nozzle 18. FIGS. 4A and 4B are alternative embodiments of the heated nozzle assembly 12, where the shank barrel 24 includes a plurality of temperature sensors 78 for monitoring a temperature profile along the shank barrel 24. Specifically, in the example as shown in FIGS. 4A and 4B, a temperature sensor 78 is provided for each heater segment 34 of the shank barrel 24. Specifically, as seen in FIGS. 4A and 4B, temperature sensors 78B, 78C, 78D, and 78E are formed within a channel 80 formed within a respective heater segment 34B, 34C, 34D, 34E, while temperature sensor 78A is formed within the nozzle tip 26.

In the non-limiting embodiment as shown in FIG. 2, the plurality of heating elements 62A, 62B, 62C, 62D, 62E are individual ohmic heating elements that includes a refractory layer 84 that surrounds a respective heater segment 34, where the refractory layer 84 acts as both an electrical insulator and a heat insulator. Referring to FIG. 4A, in another embodiment the heating elements 62 may include individual inductive coils 86 that are wound around a respective heater segment 34. In the embodiment as shown in FIG. 4B, the heating elements 62 are a combination of the ohmic heating elements and the individual inductive coils 86, where the inductive coils 86 are embedded within the refractory layer 84.

Operation of the heating elements 62 may now be described. Referring to FIG. 2, at zero print speed, only the bottom heater segment 34A is activated. It is to be appreciated that in embodiments the bore 32 of the nozzle 18 is tapered to facilitate flow of the molten thermoplastic material even when a single heater segment 34 is activated, similar to a release angle that is used in molding applications to eject parts from the mold. As the print speed increases, additional heater segments 34 are activated sequentially from bottom to top, where the top heater segment 34E is activated at maximum print speeds. Therefore, at zero print speed, the heat diffusion length H of the heated nozzle assembly 12 is equal to a height HA of the bottom heater segment 34A measured from the discharge end 30 of the nozzle 18. Similarly, at maximum print speeds, the heat diffusion length H of the heated nozzle assembly 12 is equal to a height HE of the top heater segment 34E.

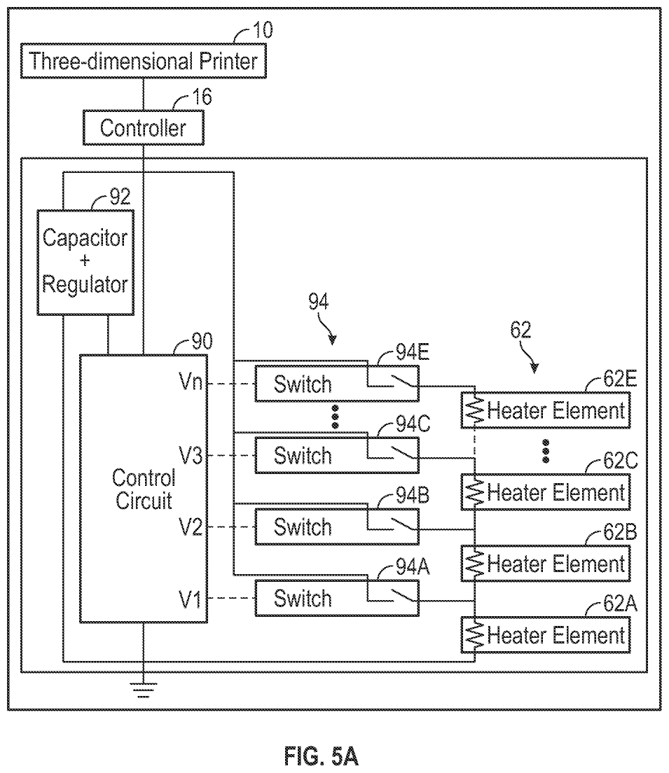

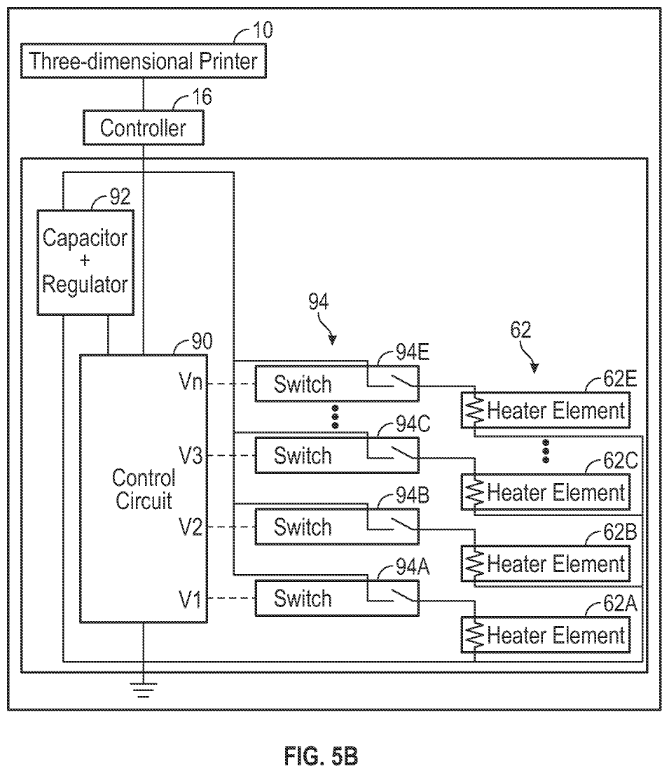

FIG. 5A illustrates an exemplary schematic diagram of the three-dimensional printer 10 including a control circuit 90 in electronic communication with the controller 16 and the heating elements 62, where the control circuit 90 activates or deactivates one or more of the plurality of heating elements 62 of the heated nozzle assembly 12, thereby controlling the melt front according to the required printing speed. The control circuit 90 is powered by voltage from the one or more controllers 16 provided to the plurality of heating elements 62. It is to be appreciated that the power provided to the control circuit 90 and the heater segments 34 may be intermittent, and in embodiment a capacitor and regulator 92 are provided that keep the control circuit 90 powered when the one or more controllers 16 are turned off. In an embodiment, the control circuit 90 is an integrated circuit referred to as a bar graph voltmeter. One commercial example of the bar graph voltmeter is the LM3914 Dot/Bar Display Driver available from Texas Instruments in Dallas, Texas, however, it is to be appreciated that other types of circuits may be used as well such as a peripheral interface controller (PIC).

In the example as shown in FIG. 5A, the control circuit 90 connects the heating elements 62 in series with one another. The control circuit 90 shown in FIG. 5B is similar to the embodiment as shown in FIG. 5A except the heating elements 62 are connected in parallel instead of series. Referring to both FIGS. 5A and 5B, the control circuit 90 is in electronic communication with a plurality of electrical switching elements 94 that connecting the heating elements 62 to one another. Specifically, each electrical switch elements 94A, 94, 94C, 94D, 94E correspond to one of the heating elements 62A, 62B, 62C, 62D, 62E. The electrical switching elements 94 may be, for example, electromagnetic relays and metal-oxide-semiconductor, field-effect transistors (MOSFET), or electromagnetic relays.

In the example where the control circuit 90 is a bar graph voltmeter, the electrical switching elements 94 are used in place of where a light-emitting diode (LED) would traditionally be found. When the bar graph voltmeter operates in dot mode, the plurality of switching elements 94 connect the heating elements 62 in series with one another as seen in FIG. 5A. When the bar graph voltmeter operates in a bar graph mode, the plurality of electrical switching elements 94 connect the heating elements 62 to one another in parallel, which is seen in FIG. 5B. In one embodiment, the control circuit 90 may be part of the controller 16.

Referring to FIGS. 2, 5A and 5B, the controller 16 monitors the temperature sensor 78 to determine the temperature of the shank barrel 24. The controller 16 determines a difference between a predefined set temperature of the shank barrel 24 and the temperature monitored by the temperature sensor 78, where the difference is a feedback error signal. The controller 16 may then determine a drive voltage based on the feedback error signal. The controller 16 then sends the drive voltage value to the control circuit 90, where the control circuit 90 activates one or more of switching elements 94 based on the drive voltage value. In the example as shown in FIGS. 4A and 4B where a plurality of temperature sensors 78 are included, the controller 16 determines the temperature of the shank barrel 24 based on a weighted average of all the temperature sensors 78.

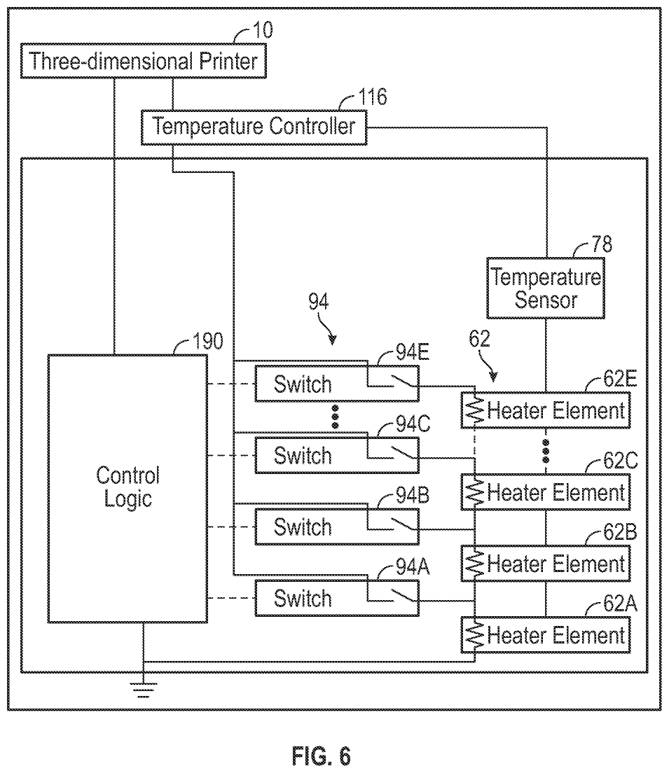

FIG. 6 illustrates an alternative embodiment of the controller 116 and control logic 190, where the controller 116 may be a dedicated temperature controller 116 instead of a main processor of the three-dimensional printer 10. In an embodiment, the control logic 190 is incorporated into the controller 116. In the embodiment as shown in FIG. 6, the controller 116 determines a specific amount of electrical power that is provided to the heating elements 62 during a print system for a specific printed component based on a print speed of the three-dimensional printer 10. Specifically, the controller 116 may determine a total number of heating elements 62 that are activated based on a maximum thermal power of each heating element 62. In other words, the controller 116 determines the total number of heating elements 62 activated during the print cycle. The controller 116 may perform a main control action. In an embodiment, the main control action is throttling power to the heating elements 62, which is performed through a feedback loop that includes the one or more temperature sensors 78.

In another embodiment, the main control action includes dynamically monitoring an amount of electrical power supplied to the heating elements 62 during the print cycle, comparing the amount of electrical power supplied to the heating elements 62 with a predetermined amount of electrical power to determine the feedback error signal, and adjusting the amount of electrical power supplied to the heating elements based on the feedback error signal. It is to be appreciated that the present approach may eliminate the time lag that is commonly associated between the temperature sensors 78 and the step changes in electrical power input to the heating elements 62.

Referring generally to the figures, the disclosed heated nozzle assembly including the plurality of discrete heater segments provides various technical effects and benefits. Specifically, the heater segments dynamically adjust the heat diffusion length of the nozzle as the print speed of the three-dimensional printer varies. The disclosed approach may result in more uniform nozzle discharge temperatures, which in turn improves print quality. The disclosed approach may also result in improved printability of softer plastic filaments, improve the strength of printed components, and reduce material degradation when transitioning from high-speed to low-speed printing. Finally, the disclosed approach results in an improved melt front control, across different print speeds.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A heated nozzle assembly for a three-dimensional printer, the heated nozzle assembly comprising:
a shank defining a feed end and a first internal flow passage, wherein the feed end is fluidly coupled to the first internal flow passage;
a nozzle tip defining a discharge end of the nozzle including a second internal flow passage;
a shank barrel coupled to the shank that includes the second internal flow passage and a body portion, wherein the second internal flow passage of the shank barrel is fluidly coupled to the first internal flow passage of the shank and the body portion of the shank barrel defines a plurality of heater segments that are disposed along the body portion of the shank barrel that are thermally isolated from one another, and wherein a bottom heater segment is located directly adjacent to the discharge end of the nozzle and a top heater segment is disposed furthest away from the discharge end of the nozzle, and wherein the heated nozzle assembly includes heat diffusion length based on an input velocity of a filament received by the feed end and a heat diffusion time;
a plurality of heating elements that each correspond to one of the plurality of heater segments disposed along a length of the body portion of the shank barrel, wherein the heating elements are each configured to heat a corresponding heater segment to a predefined temperature; and
a control circuit in electronic communication with the plurality of heating elements, wherein the control circuit activates only the bottom heating element when the three-dimensional printer is at zero print speed and the heat diffusion length is equal to a height of the bottom heater segment measured from the discharge end of the nozzle, and wherein the control circuit activates each of the plurality of heating elements when the three-dimensional printer is at a maximum print speed the heat diffusion length is equal to a height of the top heater segment.

2. The heated nozzle of claim 1, wherein the shank barrel includes one or more heat breaks disposed between two heater segments, wherein the one or more heat breaks thermally isolate the two heater segments from one another.

3. The heated nozzle of claim 2, wherein the one or more heat breaks are air gaps between the two heater segments.

4. The heated nozzle of claim 1, wherein the heating elements are ohmic heating elements, individual inductive coils, or a combination of the ohmic heating elements and the individual inductive coils.

5. The heated nozzle assembly of claim 1, wherein the shank barrel is constructed at least in part of tungsten carbide or tungsten copper alloys.

6. (canceled)

7. The heated nozzle assembly of claim 1, wherein the heat diffusion length is a product of an input velocity of the filament multiplied by a heat diffusion time.

8. (canceled)

9. (canceled)

10. The heated nozzle assembly of claim 1, wherein the control circuit includes a plurality of electrical switching elements that connect the plurality of heating elements to one another.

11. The heated nozzle assembly of claim 10, wherein the plurality of electrical switching elements connect the heating elements in series with one another.

12. The heated nozzle assembly of claim 10, wherein the plurality of switching elements connect the heating elements in parallel with one another.

13. The heated nozzle assembly of claim 1, wherein the control circuit is a bar graph voltmeter.

14. The heated nozzle assembly of claim 1, further comprising one or more temperature sensors that detect a temperature of the shank barrel.

15. The heated nozzle assembly of claim 14, wherein the heated nozzle includes a single temperature sensor.

16. The heated nozzle assembly of claim 14, further comprising a plurality of temperature sensors, and wherein a temperature sensor is provided for each heater segment of the shank barrel.

17. A three-dimensional printer, comprising:
one or more controllers;
a control circuit in electronic communication with the one or more controllers, wherein the control circuit is powered by voltage from the one or more controllers; and
a print head including a heated nozzle assembly, wherein the heated nozzle assembly comprises:
a shank defining a feed end and a first internal flow passage, wherein the feed end is fluidly coupled to the first internal flow passage;
a nozzle tip defining a discharge end of the nozzle including a second internal flow passage;
a shank barrel coupled to the shank that includes the second internal flow passage and a body portion, wherein the second internal flow passage of the shank barrel is fluidly coupled to the first internal flow passage of the shank and the body portion of the shank barrel defines a plurality of heater segments that are disposed along the body portion of the shank barrel that are thermally isolated from one another, and wherein a bottom heater segment is located directly adjacent to the discharge end of the nozzle and a top heater segment is disposed furthest away from the discharge end of the nozzle, and wherein the heated nozzle assembly includes heat diffusion length based on an input velocity of a filament received by the feed end and a heat diffusion time; and
a plurality of heating elements in electronic communication with the control circuit, wherein the plurality of heating elements each correspond to one of the plurality of heater segments disposed along a length of the body portion of the shank barrel, wherein the heating elements are each configured to heat a corresponding heater segment to a predefined temperature, and wherein the control circuit activates or deactivates one or more of the plurality of heating elements, and wherein the control circuit activates only the bottom heating element when the three-dimensional printer is at zero print speed and the heat diffusion length is equal to a height of the bottom heater segment measured from the discharge end of the nozzle, and wherein the control circuit activates each of the plurality of heating elements when the three-dimensional printer is at a maximum print speed the heat diffusion length is equal to a height of the top heater segment.

18. The three-dimensional printer of claim 17, wherein the control circuit includes a plurality of electrical switching elements connecting the plurality of heating elements to one another.

19. The three-dimensional printer of claim 18, wherein the plurality of electrical switching elements connect the heating elements in series with one another.

20. The three-dimensional printer of claim 18, wherein the plurality of switching elements connect the heating elements in parallel with one another.
